(19) United States
(12) Patent Application Publication
(10) Pub. No.: US 2009/0081514 A1
(43) Pub. Date: Mar. 26, 2009

(54) REACTOR AND SOLID OXIDE FUEL CELL

(75) Inventors: Makoto Ohmori, Nagoya-City (JP); Kunihiko Yoshioka, Nagoya-City (JP); Tsutomu Nanataki, Toyoake-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 12/233,893

(22) Filed: Sep. 19, 2008

(30) Foreign Application Priority Data
Sep. 20, 2007 (JP) 2007-244130

(51) Int. Cl. H01M 8/04; H01M 8/10

(52) U.S. Cl. 429/30; 429/34

(57) ABSTRACT

In a solid oxide fuel cell, air supplied from the outside through an air supply port Pain firstly flows through an air supply channel Hain in the downward direction to flow in air channels Sa. The air flowing into the air channels Sa flows through the air channels Sa in the lateral direction to flow out to an air discharge channel Haout. The air flowing out to the air discharge channel Haout flows through the air discharge channel Haout in the upward direction to be discharged to the outside from an air discharge port Paout. When a pressure loss ratio ΔPc/ΔPm, which is a ratio of a pressure loss ΔPc of air generated in the air channel Sa to the pressure loss ΔPm of air generated in the air supply channel Hain (or the air discharge channel Haout) during the operation of a fuel cell (at working temperature), is within 1 to 2500, the flow rate of the air flowing into each air channel can be equalized as much as possible, thereby being capable of preventing the reduction in the output.

### BACKGROUND OF THE INVENTION

1. Field of the Invention

The present invention relates to a reactor, such as a solid oxide fuel cell (SOFC), and particularly to a reactor having a (flat-plate) stack structure in which plural sheet bodies and plural support members for supporting the sheet bodies are stacked in alternating layers.

2. Description of the Related Art

Conventionally, a reactor such as an SOFC having the above-mentioned stack structure has been known (refer to, for example, Japanese Patent Application Laid-Open (kokai) No. 2007-103279). In the reactor of this type, a flow channel (reaction channel) of a gas used for a chemical reaction is formed along each of the sheet bodies between the sheet body and the support member adjacent to the sheet body.

In order to increase an output (maximum output) in the reactor having the stack structure described above, gas needs to be well supplied to each of plural reaction channels in the stack structure. In order to well supply the gas to each of plural reaction channels, it is preferable that the gas supplied from the outside (gas supplying mechanism) in the stack structure is uniformly distributed to each reaction channel in such a manner that the flow rate (or flow velocity) of the gas flowing into each reaction channel is made uniform.

Japanese Patent Application Laid-Open (kokai) No. 2007-103279 discloses a structure in which a linear gas supply channel, which has an upper end provided with a gas supply port so as to communicate with the inlet side of each reaction channel and a closed lower end, is formed along the stacking direction (in the vertical direction), and a linear gas discharge channel, which has an upper end provided with a gas discharge port so as to communicate with the outlet side of each reaction channel and a closed lower end, is formed along the stacking direction (in particular, refer to claim 3, and paragraph numbers 0019 and 0042 in the application described above).

Specifically, (as shown in a later-described FIG. 4), the gas supplied from the supply port of the supply channel firstly flows through the supply channel in the downward direction to flow into each reaction channel, the gas flowing into each reaction channel flows through the reaction channels in the lateral direction (in the horizontal direction) to flow out to the discharge channel, and the gas flowing out to the discharge channel flows through the discharge channel in the upward direction to be discharged to the outside from the discharge port.

The plural U-shaped gas channels described above are referred to as “U-shaped channel” below. Japanese Patent Application Laid-Open (kokai) No. 2007-103279 describes that, when an oxidant gas (air) flows through the “U-shaped channel”, the effect of reducing the variation in the flow rate of the gas flowing into each reaction channel is remarkable.

The present inventor has found, through various experiments, the condition capable of preventing the reduction in the output and equalizing as much as possible the flow rate of the gas flowing into each reaction channel, when gas (especially, air, or gas having a kinematic viscosity equal to that of air) flows through the “U-shaped channel” in the reactor having the stack structure provided with the “U-shaped channel”.

### SUMMARY OF THE INVENTION

A reactor such as SOFC according to the present invention includes a plurality of (flat-plate) sheet bodies in which chemical reactions occur, and a plurality of (flat-plate) support members for supporting the plurality of sheet bodies, wherein the plurality of sheet bodies and the plurality of support members are stacked in alternating layers. In the reactor according to the present invention, each of the sheet bodies is provided with a flow channel (reaction channel, the space formed between flat-plates) of a gas used for the chemical reactions between each of the sheet body and the support member adjacent to the sheet body.

The reactor according to the present invention includes a gas supply channel that is formed along the stacking direction (vertical direction) so as to communicate with the inlet side of each of the reaction channels, that has one end (upper end) provided with a supply port and an opposite end (lower end) that is closed, and through which a gas supplied from the supply port flows in one direction (downward direction) in the stacking direction for supplying the gas to each of the reaction channel, and a gas discharge channel that is formed along the stacking direction so as to communicate with the outlet side of each of the reaction channels, that has one end (upper end), which is at the same side of one end of the supply channel and is provided with a discharge port and an opposite end (lower end) that is closed, and through which the gas flowing out from each of the reaction channels flows in the direction (upward direction) reverse to the one direction in the stacking direction for discharging the gas to the outside from the discharge port. Specifically, the reactor according to the present invention has a stack structure provided with the “U-shaped channel”.

The overall reactor can be downsized, if the supply channel is directly connected to the inlet sides of the respective reaction channels, and the discharge channel is directly connected to the outlet sides of the respective reaction channels.

The reactor according to the present invention is characterized in that a ratio (ΔPc/ΔPm, hereinafter referred to as “pressure loss ratio”) of the pressure loss (ΔPc) of the gas generated in the reaction channel to the pressure loss (ΔPm) of the gas generated in the supply channel or the discharge channel during the operation of the reactor is 1 or more and 2500 or less. This condition is especially effective for the case in which the gas (e.g., air) having a kinematic viscosity of 85 mm²/s or more and 190 mm²/s or less (having relatively small kinematic viscosity) during the operation of the reactor (working temperature) is used. The gas having the kinematic viscosity equal to that of the air is referred also to “air-corresponding gas”.

Here, the pressure loss (ΔPm) of the gas generated in the supply channel or the discharge channel is the pressure difference between both ends of the supply channel or the discharge channel, while the pressure loss (ΔPc) of the gas generated in the reaction channel is the pressure difference between the end at the inlet side (inlet port) and the end of the outlet side (outlet port) of the reaction channel.

According to our studies, it has been found that, when the pressure loss ratio is less than 1 in case where the air-corresponding gas is used, the tendency of increasing the flow rate of the gas flowing into the reaction channels at the lower part (the reaction channels close to the bottom surface of the supply channel) (particularly, the tendency in which the flow rate of the gas flowing into the lowermost reaction channel is extremely increased) is significant. Conceivably, this is based upon the overwhelmingly great effect of inertia of the gas compared to the effect of viscosity of the gas, which is caused by the small kinematic viscosity of the air-corresponding gas, and the insufficient throttle effect of each of the reaction channels with respect to the throttle effect of the supply channel and the discharge channel (the detail thereof will be described later).

On the other hand, it has been found that, when the pressure loss ratio is greater than 2500, the tendency of reducing the output of the reactor becomes significant. Conceivably, this is based upon the gas that is difficult to flow through the reaction channel when the cause of increasing the pressure loss ratio lies in the small area of each of the reaction channels (i.e., small depth of each of the reaction channels). Further, when the cause of increasing the pressure loss ratio lies in the great area of the supply channel and the discharge channel, the remarkable reduction in the output of the reactor is conceivably based upon the decreased area occupied by the reaction channels (accordingly, the area contributed to the chemical reaction) due to the increased area occupied by the supply channel and the discharge channel as viewed in plane.

From the above, the pressure loss ratio is preferably 1 or more and 2500 or less. By virtue of this, the reduction in the output can be prevented, and the flow rate of the gas flowing into each reaction channel can be equalized as much as possible.

When the pressure loss ratio is 1 or more and 2500 or less, the depth of the reaction channel (height, distance between flat plates) in the stacking direction is preferably 0.15 mm or more and 0.70 mm or less.

According to our studies, it has been found that, when the depth of the reaction channel is less than 0.15 mm, the pressure loss of the reaction channel becomes excessive, whereby the pressure loss of the entire reactor becomes excessive. On the other hand, it has been found that, when the depth of the reaction channel is greater than 0.7 mm, the size of the stack structure in the stacking direction (vertical direction) becomes too great. Consequently, the depth of the reaction channel is preferably 0.15 mm or more and 0.70 mm or less.

It is more preferable that, when the pressure loss ratio is 1 or more and 2500 or less, the sectional area (channel area) of the supply channel or the discharge channel in the direction vertical to the stacking direction is 0.79 mm² or more and 19.63 mm² or less. The sectional shape of the supply channel or the discharge channel may be circular, elliptic, rectangular, square, or the like.

According to our studies, it has been found that, when the area of the supply channel or the discharge channel is less than 0.8 mm², the pressure loss of the supply channel or the discharge channel becomes excessive, whereby the pressure loss of the entire reactor becomes excessive. On the other hand, it has been found that, when the area of the supply channel or the discharge channel is greater than 20.0 mm², the size of the stack structure in the direction (lateral direction, horizontal direction) vertical to the stacking direction becomes too great. Consequently, the area of the supply channel or the discharge channel is preferably 0.8 mm² or more and 20.0 mm² or less.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a perspective view of a solid oxide fuel cell according to an embodiment of the present invention;

FIG. 2 is an exploded partial, perspective view of the fuel cell shown in FIG. 1;

FIG. 3 is a sectional view of a support member taken along a plane that includes line 3-3 of FIG. 2 and is in parallel with an x-z plane;

FIG. 4 is a vertical sectional view of the fuel cell taken along a plane that includes line 4-4 of FIG. 1 and includes a z-axis;

FIG. 5 is a vertical sectional view of the fuel cell taken along a plane that includes line 5-5 of FIG. 1 and includes a z-axis;

FIG. 6 is a view for explaining the distribution of the flow rate of air flowing into each air channel in the case where the air discharge channel is eliminated from the “U-shaped channel”;

FIG. 7 is a view for explaining the distribution of the flow rate of air flowing into each air channel in the “U-shaped channel”;

FIG. 8 is a perspective view of a solid oxide fuel cell according to the modification of the embodiment of the present invention;

FIG. 9 is a vertical sectional view of the fuel cell taken along a plane that includes line 9-9 of FIG. 8 and includes a z-axis; and

FIG. 10 is a vertical sectional view of the fuel cell taken along a plane that includes line 10-10 of FIG. 8 and includes a z-axis.

### DESCRIPTION OF THE PREFERRED EMBODIMENT

A reactor (solid oxide fuel cell) according to an embodiment of the present invention will next be described with reference to the drawings. Overall structure of fuel cell:

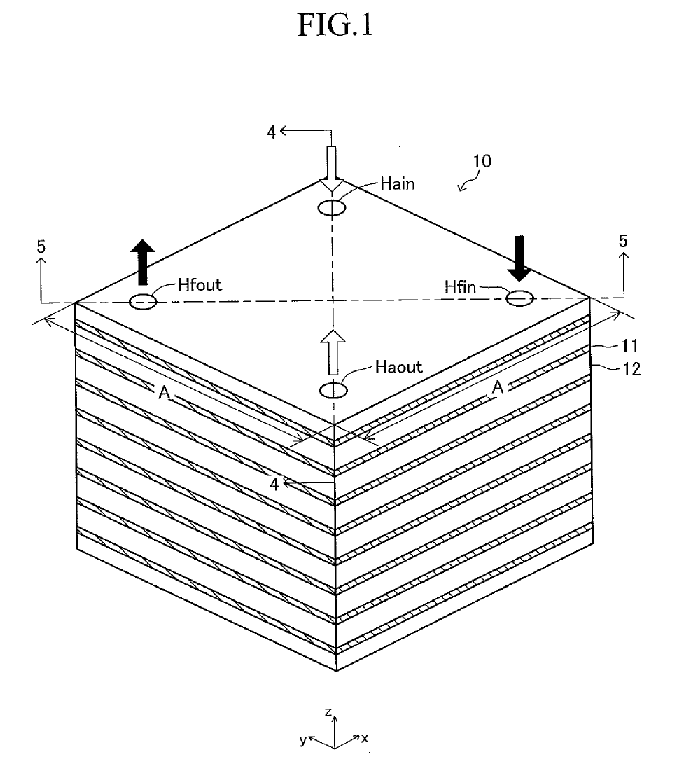

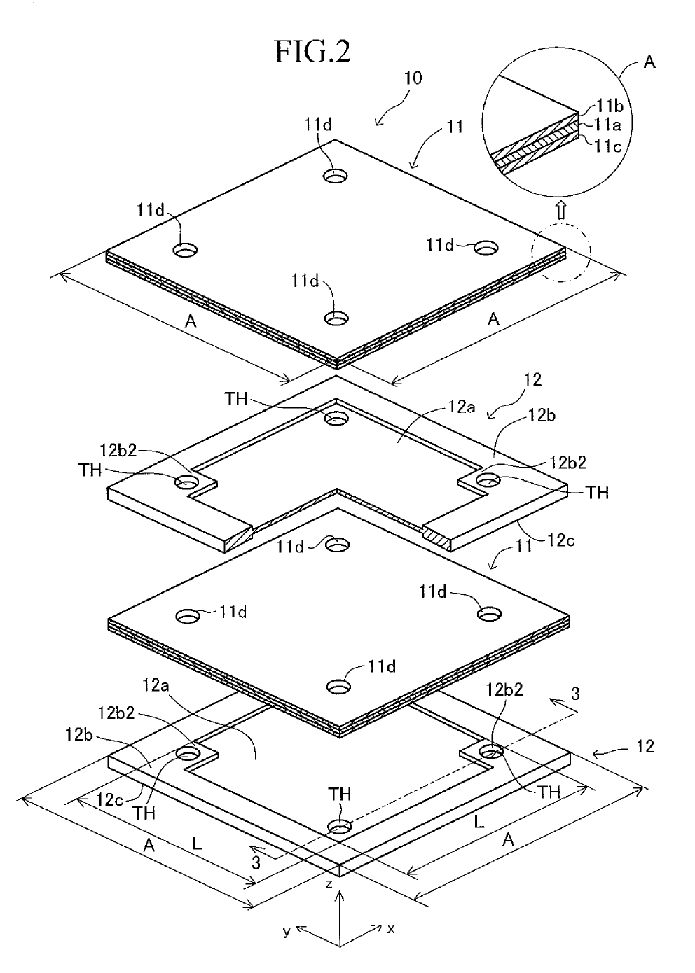

FIG. 1 perspectively shows, in a cutaway fashion, a solid oxide fuel cell (hereinafter referred to merely as the “fuel cell”) 10, which is a reactor according to an embodiment of the present invention. FIG. 2 perspectively and partially shows, in an exploded fashion, the fuel cell 10. The fuel cell 10 is configured such that sheet bodies 11 and support members 12 are stacked in alternating layers. That is, the fuel cell 10 has a flat-plate stack structure. The sheet body 11 is also referred to as a “single cell” of the fuel cell 10. The support member 12 is also referred to as an “interconnector”.

As shown on an enlarged scale within a circle A of FIG. 2, the sheet body 11 has an electrolyte layer (solid electrolyte layer) 11a, a fuel electrode layer 11b formed on the electrolyte layer 11a (on the upper surface of the electrolyte layer 11a), and an air electrode layer 11c formed on a side of the electrolyte layer 11a opposite the fuel electrode layer 11b (on the lower surface of the electrolyte layer 11a). The planar shape of the sheet body 11 is a square having sides (length of one side=A) extending along mutually orthogonal x- and y-axes. The sheet body 11 has a thickness along a z-axis orthogonal to the x-axis and the y-axis.

In the present embodiment, the electrolyte layer 11a is a dense fired body of YSZ (yttria-stabilized zirconia). The fuel electrode layer 11b is a fired body of Ni—YSZ and a porous electrode layer. The air electrode layer 11c is a fired body of LSM (La(Sr)MnO₃: lanthanum strontium manganite)—YSZ and a porous electrode layer.

The sheet body 11 has a circular cell through-hole 11d at each of four corner portions. Each of the cell through-holes 11d extends through the electrolyte layer 11a, the fuel electrode layer 11b, and the air electrode layer 11c.

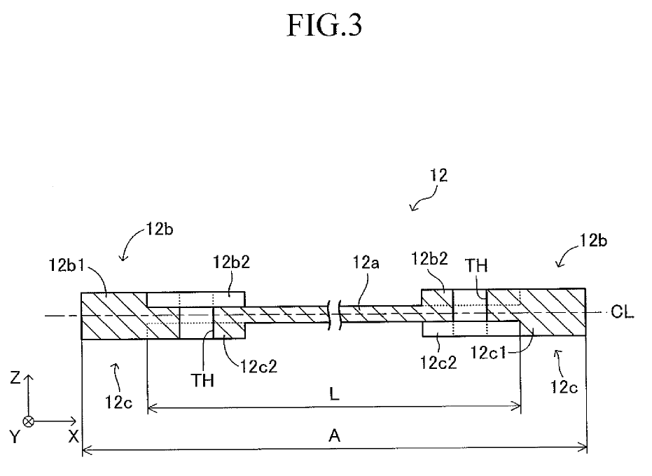

FIG. 3 is a sectional view of the support member 12 taken along plane which includes line 3-3 of FIG. 2 parallel with the x-axis and is in parallel with the x-z plane. As shown in FIGS. 2 and 3, the support member 12 includes a plane portion 12a, an upper frame portion 12b, and a lower frame portion 12c. The upper frame portion 12b and the lower frame portion 12c correspond to the “frame section”.

The planar shape of the support member 12 is a square having sides (length of one side=A) extending along mutually orthogonal x- and y-axes. The planar shape of the support member 12 is the same as the planar shape of the sheet body 11. The support member 12 is formed from an Ni-based heat-resistant alloy (e.g., ferritic SUS, INCONEL 600, or HASTELLOY).

The plane portion 12a is a thin, flat body having a thickness along the z-axis. The planar shape of the plane portion 12a is a square having sides (length of one side=L (<A)) extending along the x-axis and the y-axis.

The upper frame portion 12b is a frame body provided around the plane portion 12a (in a region in the vicinity of the four sides of the plane portion 12a; i.e., an outer peripheral region of the plane portion 12a) in an upwardly facing condition. The upper frame portion 12b consists of a perimetric frame portion 12b1 and a jutting portion 12b2.

The perimetric frame portion 12b1 is located on a side toward the perimeter of the support member 12. The vertical section of the perimetric frame portion 12b1 (e.g., a section of the perimetric frame portion 12b1 whose longitudinal direction coincides with the direction of the y-axis, taken along a plane parallel with the x-z plane) assumes a rectangular shape (or a square shape).

The jutting portion 12b2 juts toward the center of the support member 12 from the inner peripheral surface of the perimetric frame portion 12b1 at two corner portions, which are located on a diagonal line, of four corner portions of the plane portion 12a. The lower surface of each of the jutting portions 12b2 is integral with the plane portion 12a. The shape of each of the jutting portions 12b2 as viewed in plane is substantially square. The upper surface (plane) of each of the jutting portions 12b2 is continuous with the upper surface (plane) of the perimetric frame portion 12b1. Each of the jutting portions 12b2 has formed therein a through-hole TH having a diameter same as the diameter of the cell through-hole 11d. The through-hole TH also extends through a portion of the plane portion 12a that is located under the jutting portion 12b2.

The lower frame portion 12c is a frame body provided around the plane portion 12a (in a region in the vicinity of the four sides of the plane portion 12a; i.e., an outer peripheral region of the plane portion 12a) in a downwardly facing condition. The lower frame portion 12c is symmetrical with the upper frame portion 12b with respect to a centerline CL that halves the thickness of the plane portion 12a. Accordingly, the lower frame portion 12c has a perimetric frame portion 12c1 and jutting portions 12c2 that are identical in shape with the perimetric frame portion 12b1 and the jutting portions 12b2, respectively. However, the jutting portions 12c2 are formed at two corner portions, at which the jutting portions 12b2 are not formed, of four corner portions of the plane portion 12a. Each of the jutting portions 12c2 also has formed therein a through-hole TH having a diameter same as the diameter of the cell through-hole 11d. The through-hole TH also extends through a portion of the plane portion 12a that is located on the jutting portion 12c2.

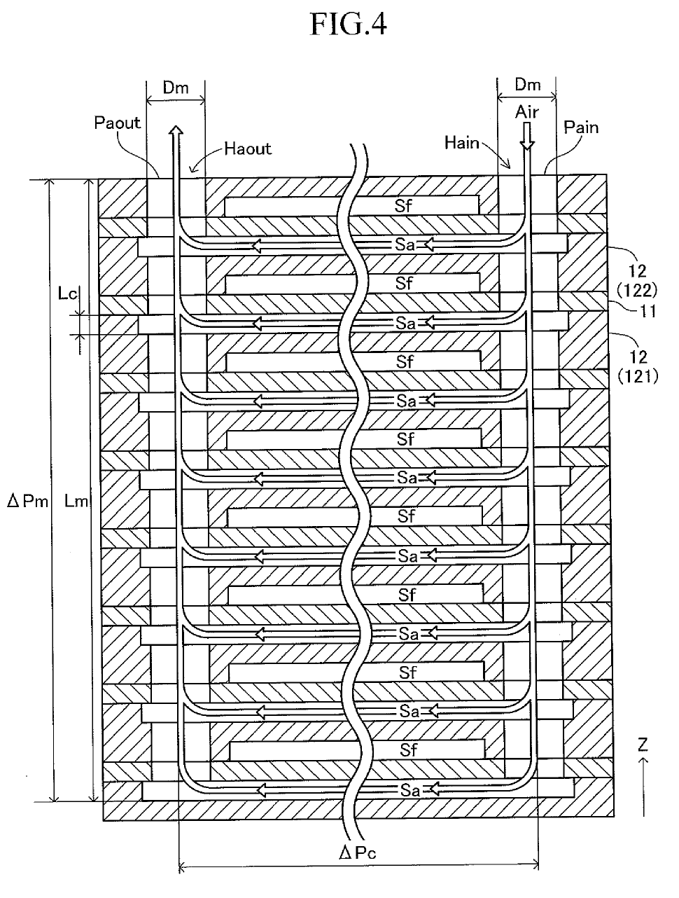

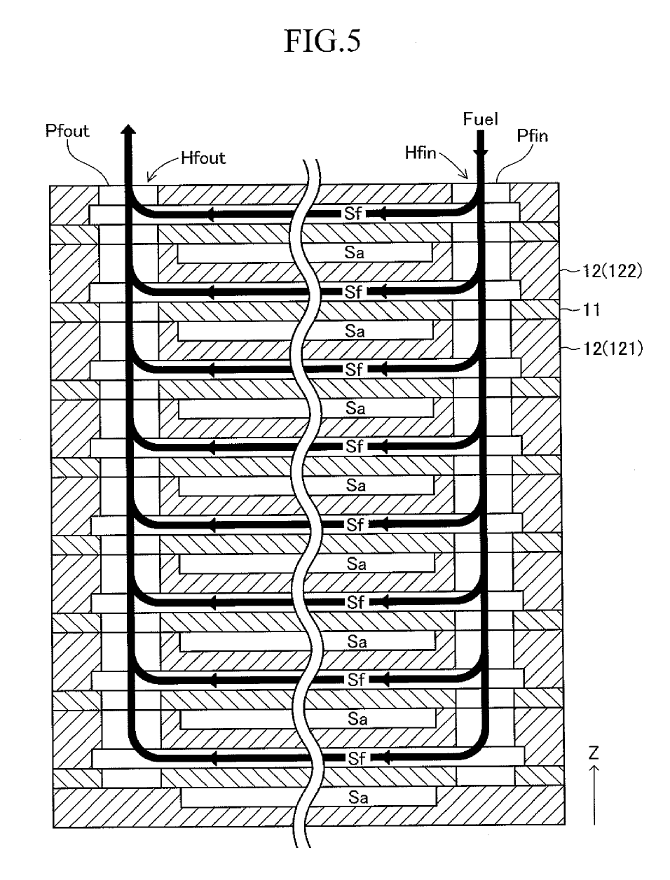

FIG. 4 is a vertical sectional view of the fuel cell 10, the sectional view being taken along a plane that includes line 4-4 (diagonal line) of FIG. 1 and includes the z-axis (vertical plane). FIG. 5 is a vertical sectional view of the fuel cell 10, the sectional view being taken along a plane that includes line 5-5 (diagonal line) of FIG. 1 and includes the z-axis (vertical plane).

As described above, the fuel cell 10 is formed by stacking the sheet bodies 1 and the support members 12 in alternating layers. For convenience of description, of the paired support members 12 supporting the sheet body 11 therebetween, the support member 12 adjacent to the lower side of the sheet body 11 is referred to as a lower support member 121, and the support member 12 adjacent to the upper side of the sheet body 11 is referred to as an upper support member 122. As shown in FIGS. 2 to 5, the lower support member 121 and the upper support member 122 are coaxially arranged such that the lower frame portion 12c of the upper support member 122 is located above the upper frame portion 12b of the lower support member 121 in a mutually facing manner.

The entire perimetric portion of the sheet body 11 is sandwiched between the upper frame portion 12b of the lower support member 121 and the lower frame portion 12c of the upper support member 122. At this time, the sheet body 11 is arranged such that the air electrode layer 11c faces the upper surface of the plane portion 12a of the lower support member 121 and such that the fuel electrode layer 11b faces the lower surface of the plane portion 12a of the upper support member 122.

The lower surface of a perimetric portion of the sheet body 11 (e.g., the lower surface of a perimetric portion of the air electrode layer 11c) is in contact with the upper surface of the upper frame portion 12b of the lower support member 121 (specifically, the upper surface of the perimetric frame portion 12b1 and the upper surface of the jutting portion 12b2) and is fixedly bonded to the upper frame portion 12b by means of a conductive predetermined bond, glass bond, or the like. Similarly, the upper surface of a perimetric portion of the sheet body 11 (i.e., the upper surface of a perimetric portion of the fuel electrode layer 11b) is in contact with the lower surface of the lower frame portion 12c of the upper support member 122 (specifically, the lower surface of the perimetric frame portion 12c1 and the lower surface of the jutting portion 12c2) and is fixedly bonded to the lower frame portion 12c by means of a conductive predetermined bond, glass bond, or the like.

In other words, the upper and lower surfaces of the entire perimetric portion of the sheet body 11 are fixedly bonded to the lower frame portion 12c of the upper support member 122 and the upper frame portion 12b of the lower support member 121, respectively. In this connection, the sheet body 11 may be fixedly bonded to the support members 12 such that the sheet body 11 is completely immovable in relation to the support members 12 or such that, only at a certain temperature or higher, the sheet body 11 is movable to a certain extent in relation to the support members 12.

Thus, as shown in FIG. 4, the upper surface of the plane portion 12a of the lower support member 121, the inner wall surface of the upper frame portion 12b (the perimetric frame portion 12b1 and the jutting portion 12b2) of the lower support member 121, and the lower surface of the air electrode layer 11c of the sheet body 11 define an air channel Sa (corresponding to the “reaction channel”), through which a gas containing oxygen (in the present embodiment, the gas is air) flows, below each of the sheet bodies 11.

The cell through-holes 11d of the sheet bodies 11 and the through-holes TH of the support members 12, which are located on the diagonal line indicated by the line 4-4 in FIG. 1 as viewed in plane, are alternately continuous in the z-axis direction (vertical direction, stacking direction), so that an air supply channel Hain and an air discharge channel Haout are formed along the z-axis direction. The sections at the air supply channel Hain and the air discharge channel Haout parallel with the x-y plane are circular (the diameter thereof is Dm).

The air supply channel Hain has its upper end an air supply port Pain, and the lower end thereof is closed. The air supply channel Hain is directly connected to the inlet side of each air channel Sa. The air discharge channel Haout has its upper end an air discharge port Paout, and the lower end thereof is closed. The air discharge channel Haout is directly connected to the outlet side of each air channel Sa.

As shown by a white arrow in FIG. 4, air supplied from the outside (unillustrated gas supplying mechanism) through the air supply port Pain firstly flows through the air supply channel Hain in the downward direction (negative direction in the z-axis) to flow in the air channels Sa. The air flowing into the air channels Sa flows through the air channels Sa in the lateral direction (horizontal direction, i.e., the direction along the x-y plane) to flow out to the air discharge channel Haout. The air flowing out to the air discharge channel Haout flows through the air discharge channel Haout in the upward direction (positive direction in the z-axis) to be discharged to the outside from the air discharge port Paout. Specifically, the fuel cell 10 has the stack structure with the above-mentioned “U-shaped channel” in relation to the air.

Similarly, the lower surface of the plane portion 12a of the upper support member 122, the inner wall surface of the lower frame portion 12c (the perimetric frame portion 12c1 and the jutting portion 12c2) of the upper support member 122, and the upper surface of the fuel electrode layer 11b of the sheet body 11 define a fuel channel Sf, through which a fuel gas (in the present embodiment, the gas is hydrogen) flows, above each of the sheet bodies 11.

The cell through-holes 11d of the sheet bodies 11 and the through-holes TH of the support members 12, which are located on the diagonal line indicated by the line 5-5 in FIG. 1 as viewed in plane, are alternately continuous in the z-axis direction (vertical direction, stacking direction), so that a fuel supply channel Hfin and a fuel discharge channel Hfout are formed along the z-axis direction. The sections at the fuel supply channel Hfin and the fuel discharge channel Hfout parallel with the x-y plane are circular (the diameter thereof is Dm).

The fuel supply channel Hfin has its upper end a fuel-gas supply port Pfin, and the lower end thereof is closed. The fuel supply channel Hfin is directly connected to the inlet side of each fuel channel Sf. The fuel discharge channel Hfout has its upper end a fuel-gas discharge port Pfout, and the lower end thereof is closed. The fuel discharge channel Hfout is directly connected to the outlet side of each fuel channel Sf.

As shown by a black arrow in FIG. 5, a fuel gas supplied from the outside (unillustrated gas supplying mechanism) through the fuel supply port Pfin firstly flows through the fuel supply channel Hfin in the downward direction (negative direction in the z-axis) to flow in the fuel channels Sf. The fuel gas flowing into the fuel channels Sf flows through the fuel channels Sf in the lateral direction (horizontal direction, i.e., the direction along the x-y plane) to flow out to the fuel discharge channel Hfout. The fuel gas flowing out to the fuel discharge channel Hfout flows through the fuel discharge channel Hfout in the upward direction (positive direction in the z-axis) to be discharged to the outside from the fuel discharge port Pfout. Specifically, the fuel cell 10 also has the stack structure with the above-mentioned “U-shaped channel” in relation to the fuel gas.

The thus-configured fuel cell 10 allows air and the fuel gas to flow by means of the “U-shaped channel” as described above, whereby electricity is generated according to Chemical Reaction Formulas (1) and (2) shown below.

(½)·O₂+2^{e-}→O²⁻(at air electrode layer 11c) (1)

H₂+O²⁻→H₂O+2^{e-}(at fuel electrode layer 11b) (2)

### Operation of U-Shaped Channel

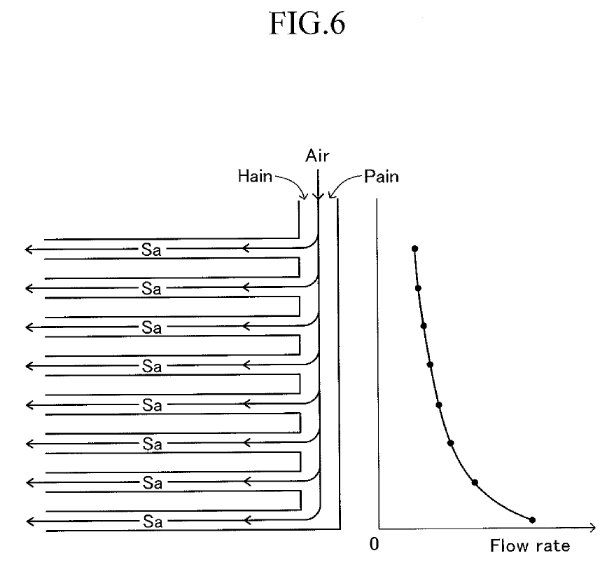

Next, the operation caused by flowing a gas having relatively small kinematic viscosity, such as air, through the “U-shaped channel” will be explained. As shown in FIG. 6, a channel (i.e., the outlet side of each of the air channels Sa is open to the outside) obtained by eliminating the air discharge port Haout from the “U-shaped channel” in relation to the air is considered.

When air is supplied from the air supply port Pain to flow through the air supply channel Hain in the downward direction (in the negative direction in the z-axis) in this channel, the flow rate of the air flowing into the air channels Sa at the lower part (in the negative direction of the z-axis, i.e., at the part close to the bottom surface of the air supply channel Hain) tends to increase (particularly, the flow rate flowing into the lowermost air channel Sa is extremely increased). This is based upon the reason described below.

Specifically, as for the air having the small kinematic viscosity, the effect of inertia is overwhelmingly great than the effect of viscosity. Accordingly, the air has a property of being difficult to change the direction of its flow. As a result, when the air flows through the linear air supply channel Hain in the downward direction, the air is easy to flow into the air channels Sa close to the bottom surface of the air supply channel Hain (at the lower part of the air supply channel Hain). In addition, since the outlet side of each of the air supply channels Sa is open to the outside, the discharge resistance of each of the air channels Sa is uniform. Thus, the flow rate of the air flowing into the air channels Sa at the lower part is increased.

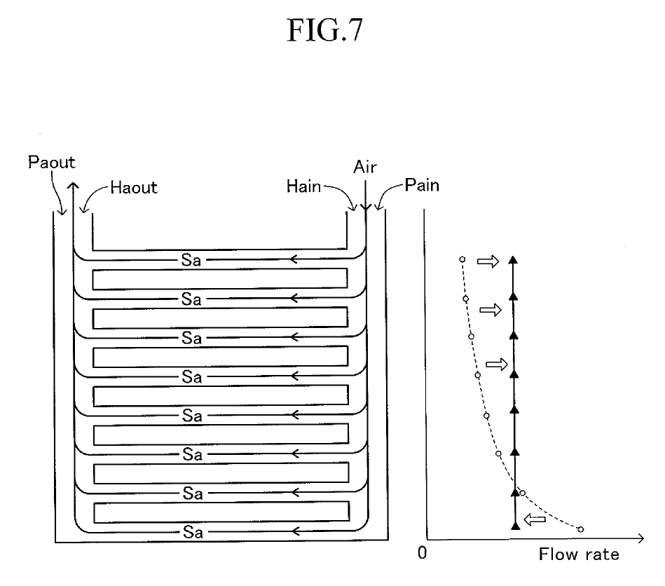

On the other hand, when the air flows through the “U-shaped channel” as shown in FIG. 7, the flow rate of the air flowing into the air channels Sa at the upper part (the air channels Sa close to the air supply port Pain) tends to increase, and the flow rate of the air flowing into the air channels Sa at the lower part (the air channels Sa close to the bottom surface of the air supply channel Hain) tends to decrease, compared to the channel shown in FIG. 6. This is based upon the condition that the discharge resistance of the air channels Sa at the lower part (the air channels Sa at the side of the negative direction of the z-axis, i.e., the air channels Sa close to the bottom surface of the air discharge channel Haout) increases because the air flows through the air discharge channel Haout in the upward direction to be discharged from the discharge port Paout.

When the air flows through the “U-shaped channel” as described above, the flow rate of the air flowing into each of the air channels Sa can be made approximately equal (the air can approximately uniformly distributed to the air channels Sa). In relation to this, the present inventor has found the conditions that make it possible to prevent the reduction in the output and to equalize as much as possible the flow rate of the air flowing into the air channels Sa, in case where air flows through the “U-shaped channel”, as described below.

Conditions That Make it Possible to Prevent Reduction In Output and to Equalize as Much as Possible Flow Rate of Air Flowing into Air Channels

The present inventor has employed the ratio (hereinafter referred to as “pressure loss ratio ΔPc/ΔPm”) of a pressure loss ΔPc of air generated in the air channel Sa to a pressure loss ΔPm of air generated in the air supply channel Hain (or in the air discharge channel Haout) during the operation of the fuel cell (at a working temperature).

As shown in FIG. 4, the pressure loss ΔPm means a pressure difference between both ends of the air supply channel Hain (or the air discharge channel Haout), while the pressure loss ΔPc means a pressure difference between the end (inlet port) at the inlet side of the air channel Sa and the end (outlet port) at the outlet side thereof. An average of the pressure differences of the air channels Sa, the pressure difference of the lowermost air channel Sa, the pressure difference of the uppermost air channel Sa, or the like can be employed as the pressure loss ΔPc.

In order to prevent the reduction in the output and equalize as much as possible the flow rate of the air flowing into the air channels Sa, the present inventor has found that the pressure loss ratio ΔPc/ΔPm is preferably 1 or more and 2500 or less. The experiment carried out for confirming the finding described above will be described below.

### Evaluation of Uniformity in Distributing Air to Each Air Channel

The output of the sheet body (cell) tends to be proportional to the flow rate of the gas passing through the upper and lower surfaces of the sheet body. Therefore, the output of each sheet body is independently measured in this experiment so as to evaluate the uniformity in distributing air to each air channel.

The condition of the experiment will be described below. A fuel cell having a flat-plate stack structure (refer to FIG. 1 or the like) that was square, as viewed in plane, whose length A of one side was 30 mm was employed. The effective area as the electrode (reacting portion) in the sheet body was about 8 cm². The number of the laminated sheet bodies (stack number, i.e., the number of the air channels) was 10. The electricity-generating temperature (working temperature) was 800° C. The air supply flow rate to the overall fuel cell was 2000 scm, and the supply flow rate of the fuel gas (hydrogen) was 600 scm.

As for the channel depth Lc of the air channel Sa (refer to FIG. 4, the distance in the z-axis direction between the upper surface of the plane portion 12a of the lower frame portion 121 and the lower surface of the air electrode layer 11c of the sheet body 11), seven levels were prepared within 0.1 mm to 0.8 mm as shown in Table 1. The lengths Lm (see FIG. 4) of the supply channel or the discharge channel corresponding to each level were as shown in Table 1. In the present embodiment, the value in the state in which the sheet body was not warped was used as the channel depth Lc.

TABLE 1

| Channel depth Lc | Length of supply/discharge channel |
|---|---|
| 0.10 mm | 4.0 mm |
| 0.15 mm | 5.0 mm |
| 0.25 mm | 7.0 mm |
| 0.35 mm | 9.0 mm |
| 0.50 mm | 12.0 mm |
| 0.70 mm | 16.0 mm |
| 0.80 mm | 18.0 mm |

The sections of the supply channel and the discharge channel were circular. As for the diameter Dm (see FIG. 4) of the channel, six levels were prepared within 0.8 mm to 6.0 mm as shown at the uppermost column in Table 2. In this experiment, the evaluation for independently measuring the output of each sheet body in case where the fuel cell was operated with the rated voltage set to 0.7 V was repeated, as the combination of the channel depth Lc (the most left line) and the channel diameter Dm (the uppermost row) was sequentially changed.

TABLE 2

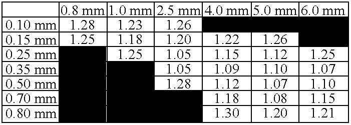

Table 2 shows the ratio (hereinafter referred to as “variation ratio”) of the maximum output and the minimum output in each combination. When the flow rate of the air flowing into the air channels is uniform (when the distribution of the air to each air channel is uniform), the variation ratio assumes “1”. In this experiment, when the variation ratio falls within the range of 1.0 to 1.3, the “uniformity in distributing the air to each air channel” was evaluated to be “satisfactory”, while when the variation ratio exceeds 1.3, the “uniformity in distributing the air to each air channel” was evaluated to be “poor”.

The dotted regions in Table 2 correspond to “poor”. Therefore, the “uniformity in distributing the air to each air channel” was evaluated to be “satisfactory” in the respective combinations of the channel depth Lc and the channel diameter Dm, which are indicated in white area.

### Evaluation of Pressure Loss at Room Temperature

The experiment for measuring the pressure losses ΔPc and ΔPm for each combination was carried out. It was difficult to measure the pressure losses when an actual fuel cell was used at the electricity-generating temperature of 800° C. Accordingly, in this experiment, the pressure losses ΔPc and ΔPm were measured under room-temperature air, serving as a substitute gas, by using dummy models of an air channel and air supply/discharge channel having generally the same shape and size as those of an actual fuel cell under the condition in which the Reynolds number was matched to that in the case where the experiment was carried out by using an actual fuel cell at an electricity-generating temperature of 800° C.

Specifically, the “dummy model of the air channel (reaction channel)” and the “dummy model of the air supply/discharge channel” were independently prepared. As the “dummy model of the air supply/discharge channel”, a cylindrical tube whose both ends were open was prepared. As the pressure difference ΔPc, the pressure difference between the inlet (corresponding to the connection portion of the air supply channel and the air channel) and the outlet (corresponding to the connection portion of the air discharge channel and the air channel) of the “dummy model of the air channel” was employed. As the pressure difference ΔPm, the pressure difference between the both ends (inlet and outlet) of the cylindrical tube was employed.

An interposed member such as a partition plate, columnar structure, mesh structure, etc. is not provided in each channel of an actual fuel cell in the present embodiment. However, when the interposed member is provided in each channel of the actual fuel cell, the pressure losses ΔPc and ΔPm are measured with a member, which is a dummy of the actual interposed member, provided to the above-mentioned dummy model.

Since the flow rate of air to the entire fuel cell is 2000 sccm at 800° C. as described above, the flow rate of the air flowing into each air channel is 200 sccm at 800° C. when the flow rate of the air flowing into the respective ten air channels is uniform. The kinematic viscosity of the air is 145 mm²/s at 800° C., and 16 mm²/s at room temperature.

The Reynolds number is in proportion to the ratio of the flow velocity (accordingly, flow rate) and the kinematic viscosity. Accordingly, in order to change the temperature of the air from 800° C. to room temperature without changing the Reynolds number in the case of using the dummy model having the size same as that of the actual fuel cell, the flow rate may be decreased in accordance with the reduction in the kinematic viscosity due to the temperature change. Specifically, in this case, the flow rate of the air flowing into air channel of the dummy model at room temperature may be set to about 22 sccm, while the flow rate of the air flowing into the air supply/discharge channel of the dummy model at room temperature may be set to about 220 sccm.

Table 3 shows the pressure loss ratio ΔPC/ΔPm when the pressure losses ΔPc and ΔPm are measured for the above-mentioned respective combinations by using the room-temperature air under the condition described above. As understood from Table 3, the combinations whose “uniformity in distributing air to each air channel” was evaluated to be “satisfactory” (corresponding to the white areas) have the pressure loss ratio ΔPc/ΔPm of 1 to 2500, while the combinations whose “uniformity in distributing air to each air channel” was evaluated to be “poor” (corresponding to the dotted areas) have the pressure loss ratio ΔPc/ΔPm of less than 1 or more than 2500.

TABLE 3

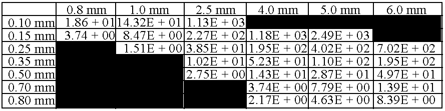

Specifically, there is a strong correlation between the result of the “uniformity in distributing air to each air channel” and the pressure loss ratio ΔPc/ΔPm. Thus, it is preferable that the pressure loss ratio ΔPc/ΔPm is 1 to 2500 at the electricity-generating temperature of 800° C. in order to equalize as much as possible the flow rate of the air flowing into each air channel.

It has been found that, when the pressure loss ratio ΔPc/ΔPm exceeds 2500, the output of the fuel cell greatly tends to decrease. From the above, when the pressure loss ratio ΔPc/ΔPm is within 1 to 2500, the flow rate of the air flowing into each air channel can be equalized as much as possible, thereby being capable of preventing the reduction in the output.

When the channel depth Lc is less than 0.15 mm in case where the pressure loss ratio ΔPc/ΔPm is within 1 to 2500, the pressure loss of the air channel becomes excessive, which makes the pressure loss of the entire fuel cell excessive. Therefore, the gas discharging capability (discharge pressure) of the external gas supplying mechanism (specifically, a small-sized pump, etc.) must be increased, which makes it difficult to fabricate a compact fuel cell system from the viewpoint of size and power consumption. On the other hand, when the channel length Lc exceeds 0.7 mm, the size of the stack structure in the stacking direction (vertical direction) becomes too great. Therefore, the output to the volume (density) of the stack decreases, so that the merit of the compact fuel cell using SOFC is lost. Since the channel depth is too great, the air flowing through the air channel (reaction channel) is less apt to spread to the surface of the cell (the air electrode layer of the sheet body), with the result that the output is remarkably reduced. Thus, the channel depth Lc is preferably 0.15 mm or more and 0.70 mm or less.

When the area (the diameter of the channel is Dm) of the supply channel or the discharge channel is less than 0.8 mm² (1.0 mm) in case where the pressure loss ratio is within 1 to 2500, the pressure loss of the supply channel or the discharge channel becomes excessive, which makes the pressure loss of the entire fuel cell excessive. Therefore, it is difficult to fabricate a compact fuel cell system from the viewpoint of size and power consumption, like the above-mentioned case. On the other hand, when the area (the diameter of the channel is Dm) of the supply channel or the discharge channel is more than 20.0 mm² (5.0 mm), the size of the stack structure in the direction (lateral direction, horizontal direction) vertical to the stacking direction becomes too great. Therefore, the output to the volume (density) of the stack decreases, so that the merit of the compact fuel cell using SOFC is lost. Thus, the area (the diameter of the channel is Dm) of the supply channel or the discharge channel is preferably 0.8 mm² or more and 20.0 mm² or less (1.0 mm or more and 5.0 mm or less).

The above description assumes the condition for equalizing as much as possible the flow rate of the air flowing into each air channel (for uniformly distributing the air into each air channel) when the air having relatively small kinematic viscosity flows through the “U-shaped channel”. On the other hand, the kinematic viscosity of the fuel gas (hydrogen) is relatively great, such as 950 mm² at 800° C. Therefore, the effect of viscosity is applied more than the effect of inertia in the hydrogen gas. Consequently, it is confirmed that the hydrogen gas is generally uniformly distributed to each fuel channel (reaction channel) under any one of the above-mentioned various conditions in the experiment.

As explained above, the solid oxide fuel cell 10 according to the embodiment of the present invention has a stack structure provided with the “U-shaped channel” for air (and fuel gas). In this structure, the ratio of the pressure loss ΔPc of the air generated in the air channel Sa to the pressure loss ΔPm of the air generating in the air supply channel Hain (or air discharge channel Haout) (pressure loss ratio ΔPc/ΔPm) at the electricity-generating temperature of 800° C. of the fuel cell is preferably 1 to 2500. According to this, the reduction in the output can be prevented, and the flow rate of the air flowing into each air channel can be equalized as much as possible.

The present invention is not limited to the above-described embodiment, but can be modified in various other forms without departing from the scope of the present invention. For example, although the “U-shaped channel” is formed for a fuel gas having relatively great kinematic viscosity in the above-mentioned embodiment, a channel in which a flowing direction of a fuel gas in the fuel discharge channel Hfout is inversed in the “U-shaped channel” may be employed for the fuel gas, instead of the “U-shaped channel”. In this case, the fuel discharge channel Hfout has its upper end closed, and the discharge port Pfout at its lower end.

In the embodiment described above, the solid oxide fuel cell in which two types of gases are flown is employed as a reactor. However, a device (e.g., microburner) having a stack structure with the “U-shaped channel” through which only one type of gas is flown may be employed.

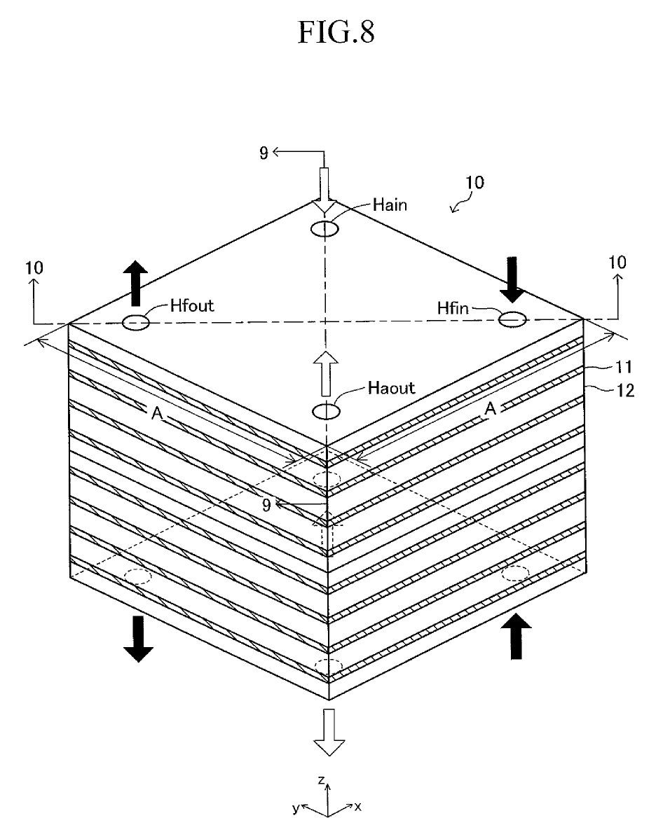

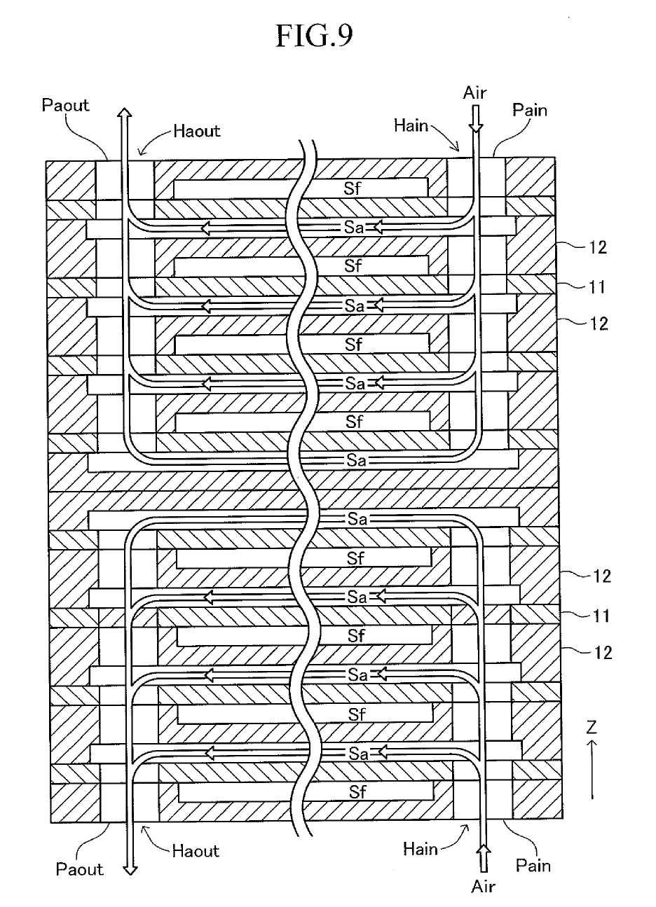

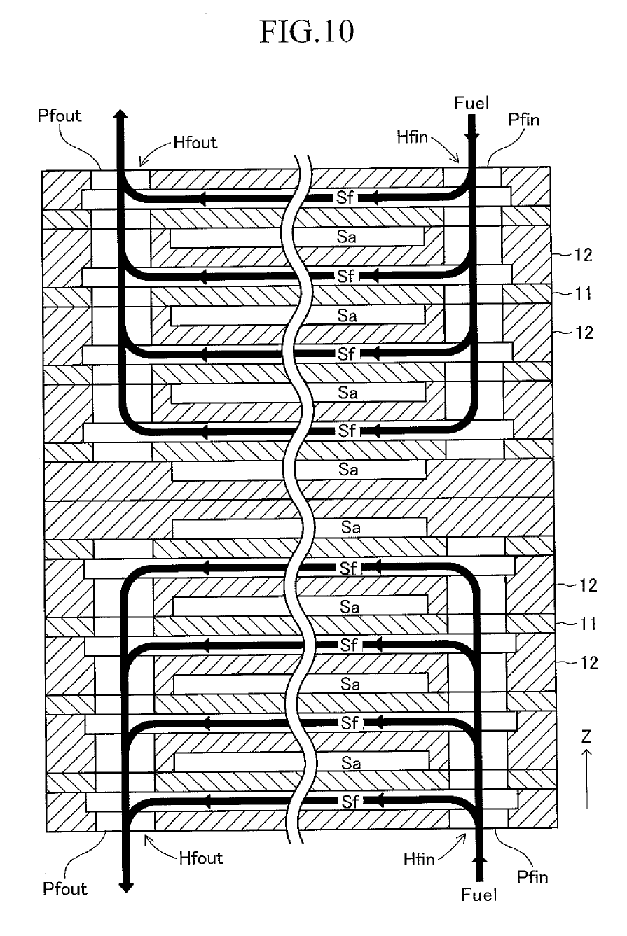

As shown in FIGS. 8, 9, and 10, which respectively correspond to FIGS. 1, 4 and 5, the invention may provide an SOFC (reactor) including a stack structure having an upper stack structure that has the “U-shaped channel” open upward (having a supply port and a discharge port at its upper surface) and a lower stack structure that has the “U-shaped channel” open downward (having a supply port and a discharge port at its lower surface), wherein the upper stack structure is bonded onto the lower stack structure (or the upper stack structure is formed integral with the lower stack structure).

The fuel electrode layer 11b can be formed from, for example, platinum, platinum-zirconia cermet, platinum-cerium-oxide cermet, ruthenium, or ruthenium-zirconia cermet.

Also, the air electrode layer 11c can be formed from, for example, lanthanum-containing perovskite-type complex oxide (e.g., lanthanum manganite or lanthanum cobaltite). Lanthanum cobaltite and lanthanum manganite may be doped with strontium, calcium, chromium, cobalt (in the case of lanthanum manganite), iron, nickel, aluminum, or the like. Also, the air electrode layer 11c may be formed from palladium, platinum, ruthenium, platinum-zirconia cermet, palladium-zirconia cermet, ruthenium-zirconia cermet, platinum-cerium-oxide cermet, palladium-cerium-oxide cermet, or ruthenium-cerium-oxide cermet.

In the above-mentioned embodiment, the sheet body 11 and the support member 12 may have a planar shape of rectangle, circle, ellipse, etc.

What is claimed is:

1. A reactor comprising:
plural sheet bodies in which a chemical reaction occurs; and
plural support members that support the plural sheet bodies; wherein the sheet bodies and the support members are stacked in alternating layers, and a reaction channel is formed between each of the sheet bodies and the support member adjacent to the sheet body, the reaction channel being a flow channel of a gas used for the chemical reaction, the reactor including:
a gas supply channel that is formed along a stacking direction of the sheet bodies and the support members so as to communicate with an inlet side of each of the reaction channels, that has one end provided with a supply port and an opposite end that is closed, and through which the gas supplied from the supply port flows in one direction in the stacking direction for supplying the gas to each of the reaction channels; and
a gas discharge channel that is formed along the stacking direction so as to communicate with an outlet side of each of the reaction channels, that has one end, which is at the same side of one end of the supply channel and is provided with a discharge port, and an opposite end that is closed, and through which the gas flowing out from each of the reaction channels flows in the direction reverse to the one direction in the stacking direction for discharging the gas to the outside from the discharge port, wherein
a ratio (ΔPc /ΔPm) of a pressure loss (ΔPc) of the gas generated in the reaction channel to a pressure loss (ΔPm) of the gas generated in the supply channel or the discharge channel during the operation of the reactor is 1 or more and 2500 or less.

2. A reactor according to claim 1, wherein
the depth (Lc) of the reaction channel in the stacking direction is 0.15 mm or more and 0.70 mm or less.

3. A reactor according to claim 1, wherein
the sectional area of the supply channel or the discharge channel in the direction vertical to the stacking direction is 0.8 mm² or more and 20.0 mm² or less.

4. A reactor according to claim 1, wherein
the kinematic viscosity of the gas during the operation of the reactor is 85 mm²/s or more and 190 mm²/s or less.

5. A reactor according to claim 1, wherein
the supply channel is directly connected to the inlet side of each of the reaction channels, and the discharge channel is directly connected to the outlet side of each of the reaction channels.

6. A solid oxide fuel cell comprising:
a plurality of sheet bodies each of which is a fired laminate of a solid electrolyte layer, a fuel electrode layer formed on an upper surface of the solid electrolyte layer, and an air electrode layer formed on a lower surface of the solid electrolyte layer; and
a plurality of support members for supporting the plurality of sheet bodies, each support member having a plane portion, and a frame portion provided along the entire perimeter of the plane portion and thicker than the plane portion,
the solid oxide fuel cell being configured such that the plurality of sheet bodies and the plurality of support members are stacked in alternating layers,
each of the sheet bodies is held between an upper support member, which is the support member adjacent to and located above the sheet body, and a lower support member, which is the support member adjacent to and located below the sheet body, in such a manner that a perimetric portion of the sheet body is sandwiched between the frame portion of the upper support member and the frame portion of the lower support member, whereby a lower surface of the plane portion of the upper support member, an inner wall surface of the frame portion of the upper support member, and an upper surface of the fuel electrode layer of the sheet body define a fuel channel to which a fuel gas is supplied, and whereby an upper surface of the plane portion of the lower support member, an inner wall surface of the frame portion of the lower support member, and a lower surface of the air electrode layer of the sheet body define an air channel to which a gas containing oxygen is supplied,
the solid oxide fuel cell including:
a gas supply channel that is formed along a stacking direction of the sheet bodies and the support members so as to communicate with an inlet side of each of the air channels, that has an upper end provided with a supply port and a lower end that is closed, and through which the gas containing oxygen supplied from the supply port flows in one direction in the stacking direction for supplying the gas containing oxygen to each of the air channels; and
a gas discharge channel that is formed along the stacking direction so as to communicate with an outlet side of each of the air channels, that has an upper end provided with a discharge port and a lower end that is closed, and through which the gas containing oxygen flowing out from each of the air channels flows in the direction reverse to the one direction in the stacking direction for discharging the gas containing oxygen to the outside from the discharge port, wherein
a ratio (ΔPc /ΔPm) of a pressure loss (ΔPc) of the gas containing oxygen generated in the air channel to a pressure loss (ΔPm) of the gas containing oxygen generated in the supply channel or the discharge channel during the operation of the solid oxide fuel cell is 1 or more and 2500 or less.

7. An solid oxide fuel cell according to claim 6, wherein
the thickness of each of the sheet bodies is 20 μm or more and 500 μm or less.
